(19) United States
(12) Patent Application Publication
(10) Pub. No.: US 2008/0056232 A1
(43) Pub. Date: Mar. 6, 2008

(54) WEBPHONE VOICE & DATA COMMUNICATIONS INTERFACE UNDER SIP FRAMEWORK

(75) Inventors: Ng Cheng Koon, Taipei County (TW); Chih-Ming Lin, Hsinchu (TW); Chia-Hui Lin, Taipei City (TW)

Correspondence Address: J C PATENTS, INC., 4 VENTURE, SUITE 250, IRVINE, CA, 92618, US

(73) Assignee: ACCTON TECHNOLOGY CORPORATION, Hsinchu (JP)

(21) Appl. No.: 11/468,611

(22) Filed: Aug. 30, 2006

(51) Int. Cl. H04L 12/66

(52) U.S. Cl. 370/352

(57) ABSTRACT

A system and method for allowing a person to place a call to another person under the SIP framework when viewing a display portion on a webpage with only one click of a mouse or one press of a keyboard key and using a stand-alone communication program is provided. The above system includes a client end, a server, a service end, an application program obtained from a server, a user-executable portion accessible at the client end on a webpage, a digital certificate authenticated against a digital signature, an active communication channel established between the client end and the service end, a ready message displayed on the webpage, an active communication session established at the client end and the service end, a session key for session registration, and one or more voice communication devices.

### BACKGROUND OF THE INVENTION

1. Field of the Invention

The present invention generally relates to a webphone voice and data communications interface, and more particularly to a system and method for allowing a person to place a call in voice or data to a seller when viewing a display portion on a webpage with only one click of a mouse or one press of a keyboard key and using a stand-alone communication program under the SIP framework.

2. Description of Related Art

Electronic commerce that utilizes the Internet to sell goods and services to customers has been increasing in its scope and scale at increasing rates. One of the main limitations on this form of commerce is the lack of a seamless direct voice interaction between the buyers and the sellers, which is present in most face-to-face business transactions. The merchants and other sellers of goods and services have been hindered at times by an inability to communicate verbally to a potential customer because the potential customer is reluctant or unable to do one or more of the following:

1) placing a call to the merchant at a “1-800” or regular long distance telephone number provided by the merchant because the customer has only one phone line for supporting both internet and telephone services;

2) placing a call to the merchant using a voice chat software, such as SKYPE™, because of not having the proper compatible voice chat software or other related voice chat software incompatibility issues;

3) placing a call to the merchant using a telephone because the customer is afraid that his or her personal information is compromised or at risk if the merchant has the caller display function enabled or any other ability to trace phone calls from the customer;

4) it is considered to be too much of a hassle for a potential customer to try to figure out the various ways and means to make the voice and data communications to the merchant;

5) having the burden to have to pay for a voice call if the telephone number provided by the merchant is not toll-free; and/or

6) where a busy tone is continuously heard when there is no one available to answer the phone at the merchant end during an actual voice call.

It is commonly known that the ability for a purchaser of goods or services at a website to have easy and quick access for purchase information is important for business. These aforementioned limitations and drawbacks of the existing web-based commerce systems limit the effectiveness of these systems to both the buyers and the sellers. New mechanisms to connect interested buyers and sellers who use these commerce systems may address and/or overcome these limitations and thus increase on-line sales, service quality, and/or corresponding profits for these sellers and commerce system operators.

### SUMMARY OF THE INVENTION

The present invention is directed to a method for implementing a webphone voice and data communications interface under the SIP framework upon the viewing of a display portion on a webpage with only one click of a mouse or one press of a keyboard key.

The present invention is also directed to a system for the implementation of a webphone voice and data communications interface corresponding to the aforementioned method.

The present invention allows for a buyer or a customer to place a call using voice and/or data to a merchant, a service provider, a sales person, a customer service representative, or any other entities when viewing a display portion on a webpage by requiring only one click of a mouse or one press of a keyboard key in the SIP environment. As a result, the aformentioned limitations and drawbacks of existing web-based commerce systems are no longer a factor.

A method for implementing a webphone voice and data communications interface under the SIP framework according to a first embodiment of the present invention is as follows:

a) access is initiated by a user at a client end via a click of a mouse button on a user-executable portion disposed on a webpage;

b) an application program obtained from a server is launched;

c) a digital certificate is authenticated at the client end against a digital signature;

d) an “INVITE” message is sent to the server;

e) the “INVITE” message is then redirected to a service end;

f) an active communication channel is established between the client end and the service end;

g) a ready message is displayed on the webpage at the client end;

h) a communication session is launched;

i) the communication session is registered using a session key;

j) communicating using a plurality of voice communication devices at the client end and at the service end;

k) voice data are extracted and transmitted between the client end and the service end;

l) at the termination of the communication session, the active communication channel is torn down between the client and the service end; and

m) the application software, the application program, and a voice communication interface panel on the webpage are shutted down.

A system for implementing a webphone voice and data communications interface according to the aforementioned method includes the following: the client end, the server, the service end, the application software, the application program, an user-executable portion (disposed on a webpage), the digital certificate, the active communication channel, the ready message (displayed on the webpage), the communication session, the session key, and one or more of voice communication devices.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a webphone voice & data communications interface under the SIP framework according to an embodiment of the present invention.

FIG. 2 is a block diagram of a system for the implementation of the webphone voice & data communications interface according to the embodiment of the present invention.

FIG. 3 is a flow chart illustrating a method for implementing the webphone voice and data communications interface according to a first embodiment of the present invention.

FIG. 4 is a flow chart illustrating a method for implementing the webphone voice and data communications interface according to a second embodiment of the present invention.

FIG. 5 is a flow chart illustrating a method for implementing the webphone voice and data communications interface according to a third embodiment of the present invention.

FIG. 6 is a flow chart illustrating a method for implementing the webphone voice and data communications interface according to a fourth embodiment of the present invention.

### DETAILED DESCRIPTION OF THE EMBODIMENTS

The present invention will now be described with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

In the drawings, whenever the same element reappears in subsequent drawings, it is denoted by the same reference numeral.

For the sake of convenience of understanding, some key terms are first presented.

A “client end” is a webpage in a web browser such as Internet Explorer™, Netscape™ Navigator®, Netscape Browser™, Opera™, Mozilla™, Mozilla Firefox™, etc. . . . , an Adobe™ Flash®_page, or an Adobe™ Shockwave® page with a display portion and a user-executable portion.

A “server” is a web server, an application server, a peer-to-peer server, a database server, a media server, a Skype™ client as a server, a mobile server, a proxy server, a redirect server, a registration server, or any other similar types of devices capable of handling the necessary SIP network communications.

A “service end” is a computer, a lap top, a desktop, a mainframe, a mobile phone, a PDA, a telephone, a two-way radio, a wireless communication device, a server, a web host, or any other similar types of network devices capable of performing the communication and processing functions required for fulfilling the needs of the “client end”. Furthermore, the “service end” is to have internet access through either wired or wireless networks.

A “user-executable portion” is defined as a hot button, an animated GIF, a JPEG drawing, a html-tagged text, a photo, a banner, a button, a hover button, a JPG photo, an Adobe™ Flash® object, an Adobe™ Shockwave® object, an activeX object, a Java applet object, a clickable hyperlink, or any other similar types of clickable html embedded objects.

An “application program” is defined as a software program, a java applet, a Java application, an activeX control object, a Javascript object, a Vbscript object, a Microsoft® ASP.NET web service, or any other similar types of software objects.

An “application software” is defined as a software program, a java bean, a Microsoft® ASP.NET web service, or any other fully functional software solutions which are capable of managing, interacting, and supporting a plurality of concurrent communications sessions, wherein each session is running an “application program”.

A “voice communication device” is a IP phone, a mobile phone, a headset, a microphone and a speaker, an intercom, a two-way radio, a wireless headset, a bluetooth headset, a built-in microphone, or any other similar types of devices capable of handling the voice communications under the SIP framework.

A “digital certificate” is based upon public key infrastructure (PKI), X.509 Digital Certificate standard, or SSL Certificates, wherein the SSL Certificates may have at least 128 bits.

As used herein, the words “may” and “may be” are to be interpreted in an open-ended, non-restrictive manner. At minimum, “may” and “may be” are to be interpreted as definitively including structure or acts recited.

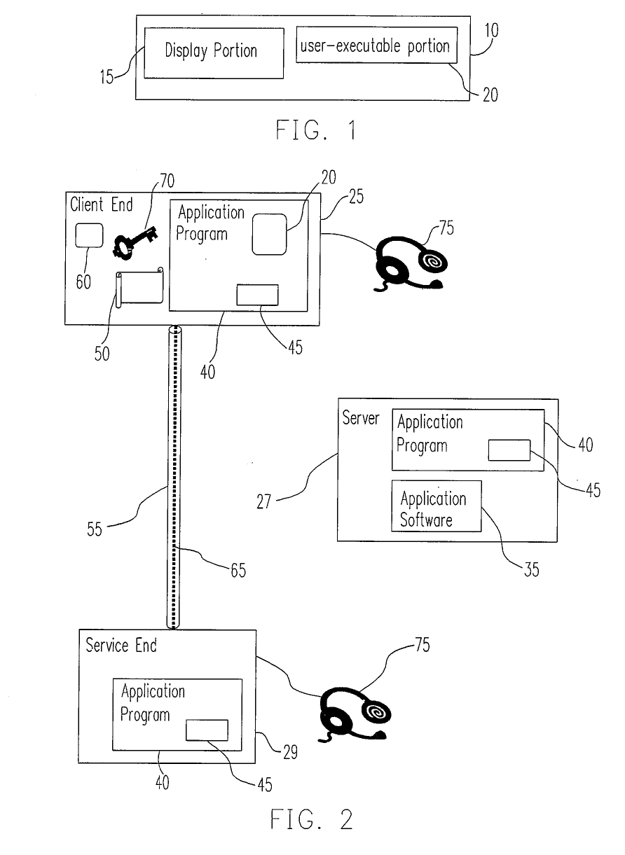

Referring to FIG. 1, a webphone voice & data communications interface 10 under the SIP framework according to an embodiment of the present invention is illustrated. The webphone voice & data communications interface 10 includes a display portion 15 and a user-executable portion 20.

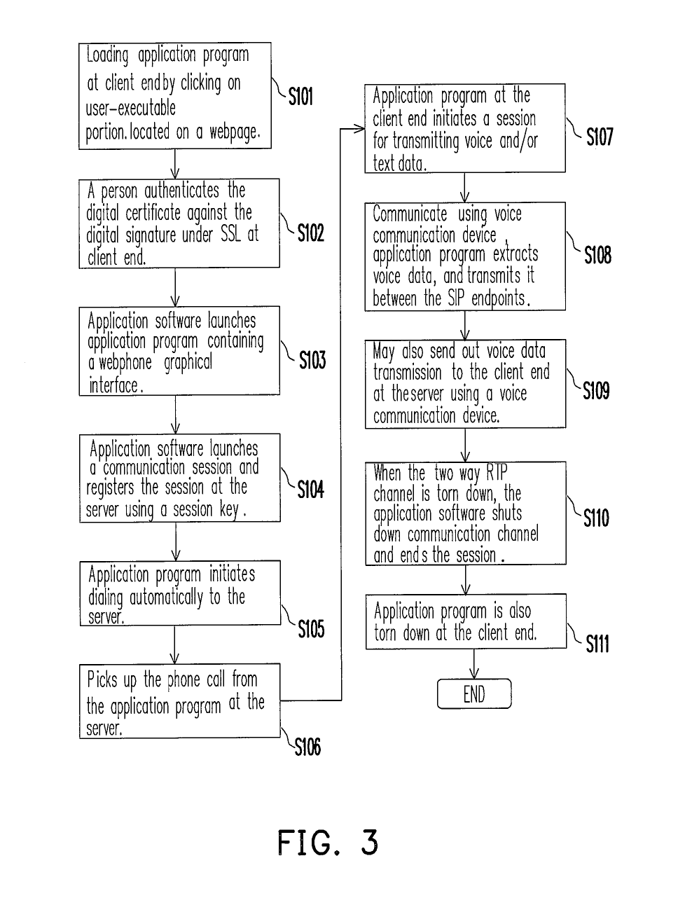

Referring to FIG. 2, a block diagram of a system for the implementation of the webphone voice & data communications interface 10 under the SIP framework according to the embodiment of the present invention is shown. The aforementioned system may include the following: a client end 25, a server 27, a service end 29, an application software 35, a plurality of application programs 40 wherein each having a pop-up webphone graphical interface 45, the user-executable portion 20, a digital certificate 50, an active communication channel 55, a ready message 60, a communication session 65, a session key 70, and one or more of voice communication devices 75.

### First Embodiment

Referring to FIG. 3, a method for implementing a webphone voice & data communications interface 10 under the SIP framework according to a first embodiment of the present invention is described as follows:

1. A person at the client end loads an application program, downloaded from a server, by clicking on the user-executable portion located on a webpage (S101).

2. The person at the client end authenticates the digital certificate sent from the application program against the digital signature under SSL framework, which is known as a certification authority (CA) (S102).

3. The application software launches the application program at the client end in the form of an applet window or activeX control containing a webphone graphical interface (S103).

4. The application software launches a communication session and registers the communication session at the server using a session key (S104).

5. The application program then automatically initiates dialing to the server (S105).

6. A person at the server picks up the phone call from the application program at the client end (S106).

7. The application program at the client end initiates the communication session to transmit voice and/or text data (S107).

8. A person at the client end may communicate using a microphone or any other voice communication device, and then the application program at the client end extracts the voice and/or text data, and transmits the voice and/or text data between the SIP endpoints, which are the client end, the server, and the service end, after a SIP transaction is established (S108). RTP/RTCP (Real Time Transport Protocol/Real Time Control Protocol) may be used to transmit the voice data.

9. The person at the server using a voice communication device, for example, an IP phone, through a 2-way RTP channel, may also send out voice data transmission to the client end (S109).

10. When the two-way RTP channel between the client end and the server is torn down, the application software shuts down the active communication channel and ends the communication session (S110).

11. The application program in the form of a pop-up webphone graphical interface is also torn down at the client end (S111).

### Second Embodiment

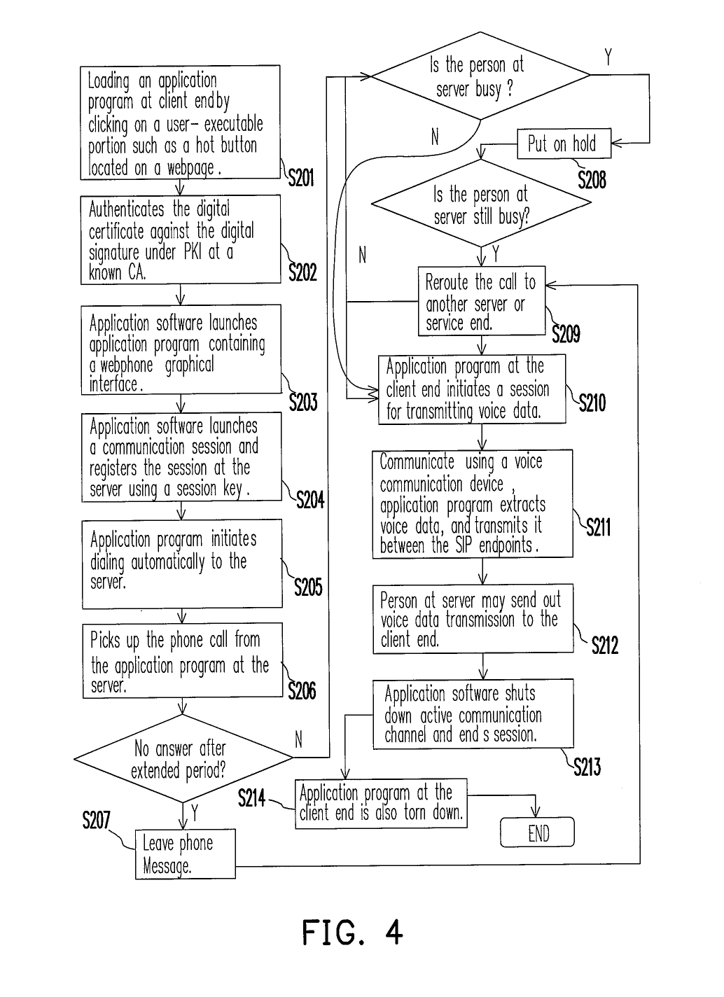

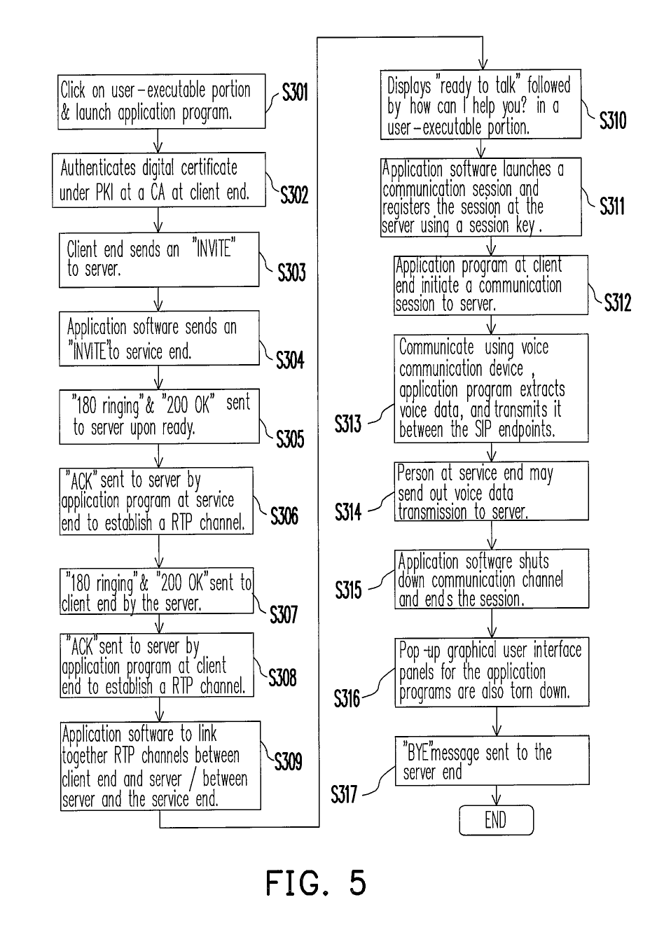

Referring to FIG. 4, a method for implementing the webphone voice & data communications interface according to a second embodiment of the present invention is described as follow:

1. A person at the client end loads an application program obtained from a server by clicking on a user-executable portion such as a hot button located on a webpage (S201).

2. The client end authenticates the digital certificate sent from the application program against the digital signature under PKI at a known certification authority (CA) (S202).

3. The application software launches an application program in the form of an applet window or activeX control containing the webphone graphical interface (S203).

4. The application software launches a communication session between the application programs at the client end and the server and registers the session at the server using a session key (S204).

5. A person using the application program at the client end automatically initiates dialing to the server (S205).

6. A person at the server picks up the phone call from the application program at the client end (S206).

7. If no answer is received after an extended period for waiting, a phone message can be left (S207).

8. If the person at the server is busy, the caller (the person at the client end making the call) can be put on hold (S208).

9. If the person at the server is still busy, the call can be rerouted to another server or a service end (S209).

10. The application program at the client end initiates a communication session for voice data transmission (S210).

11. The person at the client end communicates using a voice communication device such as a microphone; the application program at the client end then extracts the voice data, and transmits the voice data between the SIP endpoints (the client end and the server) after a SIP transaction is established (S211). RTP/RTCP is used for transmitting the voice data.

12. The person at the server using a voice communication device, for example, an IP phone, through the 2-way RTP channel, may also send out voice data transmission to the client end (S212).

13. When the two-way RTP channel between the client end and the server is torn down, the application software shuts down the active communication channel and ends the communication session (S213).

14. The application program in the form of a pop-up webphone graphical interface panel is also torn down at the client end (S214).

### Third Embodiment

Referring to FIG. 5, a method for implementing the webphone voice & data communications interface according to a third embodiment of the present invention is described as follows:

1. A user clicks on an user-executable portion disposed on a webpage, and launches the application program, which may be in the form of a java applet, a java program, an activeX control obtained from a web server, or a preinstalled activeX control located at the client end (S301).

2. The client end authenticates the digital certificate sent from the application program at a server against the digital signature under PKI at a certification authority (CA), which is then stored at the client end (S302).

3. The client end sends an “INVITE” message to the server (S303).

4. The application software at the server sends an “INVITE” message to a service end (S304).

5. The service end sends a “180 ringing” and a “200 OK” messages to the server in accordance to the SIP framework, upon fulfilling the condition that the personnel at the service end is ready for initiating voice and/or text communications (S305).

6. The application program at the service end sends an “ACK” message to the server for establishing an active 2-way RTP channel for communications (S306).

7. The server then sends a “180 ringing” and a “200 OK” messages to the client end (S307).

8. The application program at the client end sends an “ACK” message to the server for establishing the active 2-way RTP channel (S308).

9. The application software at the server then links or configures together the active 2-way RTP channels between A) that of the client end and the server, and B) that of the server and the service end (S309).

10. The application software may display a “ready to talk” or “ready” or “name of a person” followed by “how can I help you?” in a variety of language options in a pop-up window or the user-executable portion on the webpage (S310).

11. The application software at the server then launches a communication session and registers the communication session at the server using a session key (S311).

12. The application program at the client end initiates a communication session to the server (S312).

13. A person at the client end may communicate using a voice communication device such as a microphone; and then the application program at the client end extracts the voice data, and transmits the voice and/or text data between the SIP endpoints, which are the client end, the server, and the service end, after a SIP transaction is established (S313).

14. A person at the service end using a voice communication device such as an IP phone, through the 2-way RTP channel, may also send out voice or text data transmission to the server (S314).

15. When the RTP channels between the client end and the server and between the server and the service end are torned down, the application software at the server shuts down the active communication channel and ends the communication session (S315).

16. The pop-up graphical user interface panels for the application programs at both the client end and the service end are also torned down upon the termination of all communications (S316).

17. A “BYE” message is then sent from either the client end to the server end or from the service end to the server end to end all communications (S317).

### Fourth Embodiment

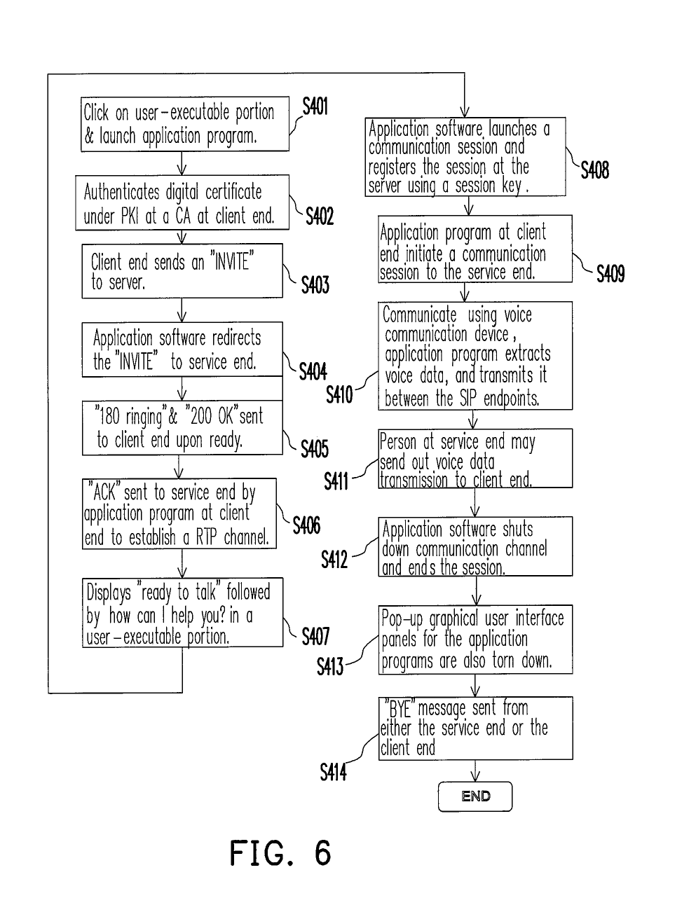

Referring to FIG. 6, a method for implementing the webphone voice & data communications interface according to a fourth embodiment of the present invention is described as follows:

1. A user clicks on a user-executable portion disposed on a webpage for launching an application program obtained from a server (S401).

2. The client end authenticates the digital certificate against the digital signature under PKI at a certification authority (CA), which is then stored at the client end (S402).

3. The client end sends an “INVITE” message to the server (S403).

4. An application software at the server redirects the “INVITE” message sent from the client end to a service end (S404).

5. The service end sends a “180 ringing” and a “200 OK” messages to the client end upon the condition that the personnel at the service end is ready for initiating voice communications (S405).

6. The application program at the client end sends an “ACK” message to the service end for establishing an active 2-way RTP channel (S406).

7. The application program at the client end may display a “ready to talk” or “ready” or the name of the person followed by “how can I help you?” in a variety of language options in a pop-up window or an embedded communications graphical user interface on the webpage (S407).

8. The application software at the server then launches a communication session and registers the communication session using a session key (S408).

9. The application program at the client end initiates a communication session to the service end (S409).

10. A person may communicate at the client end using a microphone or another voice communication device; the application program extracts the voice data, and transmit the voice and the data between the SIP endpoints after a SIP transaction is established (S410).

11. A person using an IP phone, through the 2-way RTP channel, at the service end may also send out the voice data transmission to the client end (S411).

12. When the 2-way RTP channel between the client end and the service end is torned down, the application software at the server shuts down the active communication channel and ends the communication session (S412).

13. The pop-up application graphic user interface panels or the embedded communications graphical user interfaces at both the client end and the service end are also torned down upon the termination of all communications (S413).

14. A “BYE” message is then sent from either the client end or the service end to end all communications (S414).

### Fifth Embodiment

Although the previous embodiments describe of methods and systems having a client end 25, a server 27, and a service end 29, a fifth embodiment of the present invention of a system for implementing a webphone voice and data communications interface under the SIP framework have a plurality of client ends 25, a plurality of servers 27, and/or a plurality of service ends 29 capable of implementing the methods described in the first through the fourth embodiments of the present invention.

### Sixth Embodiment

Another method for implementing a webphone voice and data communications interface, according to a sixth embodiment of the present invention is also proposed as follows: access is initiated at a client end 25 via a click of a mouse button on an user-executable portion 20; an application program 40 obtained from a server 27 is launched; an active communication channel 55 is established; a communication session 65 is launched and registered; and voice communications using a plurality of voice communication devices 75 are performed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for implementing a webphone voice and data communications interface under the SIP framework, comprising:
initiating access by a client end via a click of a mouse button on an user-executable portion;
launching an application program obtained from a server;
sending and redirecting an “INVITE” message;
establishing an active communication channel;
launching and registering a communication session; and
performing voice communications using a plurality of voice communication devices.

2. The method as claimed in claim 1, wherein the application program is a java applet.

3. The method as claimed in claim 1, wherein the application program is comprising of a plurality of javascript codings.

4. The method as claimed in claim 1, wherein the application program is comprising of an activeX control.

5. The method as claimed in claim 1, wherein the voice communication device is selected from the group consisting of an IP phone, a mobile phone, a headset, a microphone and a speaker, an intercom, a two-way radio, a wireless headset, a bluetooth headset, and a built-in microphone.

6. The method as claimed in claim 1, further comprising:
authenticating a digital certificate;
displaying a ready message;
tearing down the active communication channel; and
shutting down the application software and the application programs.

7. The method as claimed in claim 6, wherein the digital certificate is based upon a public key infrastructure (PKI).

8. The method as claimed in claim 6, wherein the digital certificate is based upon a X.509 Digital Certificate standard.

9. A method for implementing a voice and/or data communication session under the SIP framework, comprising:
initiating access by a client end via a click of a mouse button on an user-executable portion;
launching an application program obtained from a server;
authenticating a digital certificate under PKI framework;
sending and redirecting a plurality of “INVITE” messages;
sending a “180 ringing” message and a “200 OK” message to the client end;
sending an “ACK” message to the service end;
displaying a ready message on the webpage;
launching and registering a communication session;
performing voice communication using a plurality of voice communication devices;
tearing down an active communication channel between the client and the service end; and
shutting down the application software, the application programs, and a pop-up webphone graphical interface on the webpage.

10. The method as claimed in claim 9, wherein the application program is a java applet.

11. The method as claimed in claim 9, wherein the application program comprising of a plurality of javascript codings.

12. The method as claimed in claim 9, wherein the application program is an activeX control.

13. The method as claimed in claim 9, wherein the digital certificate is based upon a public key infrastructure (PKI).

14. The method as claimed in claim 9, wherein the digital certificate is based upon a X.509 Digital Certificate standard.

15. The method as claimed in claim 9, wherein the voice communication device is selected from the group consisting of an IP phone, a mobile phone, a headset, a microphone and a speaker, an intercom, a two-way radio, a wireless headset, a bluetooth headset, and a built-in microphone.

16. A system for implementing a webphone voice and data communications interface under the SIP framework, comprising:
one or more client ends, one or more servers, and one or more service ends;
an application software;
a plurality of application programs, obtained from a server;
a user-executable portion, disposed on a webpage and accessed by a client end via a click of a mouse button;
an active communication channel, established between the client end and the service end;
a communication session, established at the client end and the service end;
a session key, for registering the session; and
one or more voice communication devices.

17. The system as claimed in claim 16, further comprising:
a digital certificate, authenticated against a digital signature under a PKI infrastructure; and
a ready message, displayed on the webpage at the client end.

18. The system as claimed in claim 16, wherein the voice communication device is selected from the group consisting of an IP phone, a mobile phone, a headset, a microphone and a speaker, an intercom, a two-way radio, a wireless headset, a bluetooth headset, and a built-in microphone.

19. A method for implementing a webphone voice and data communications interface, comprising:
initiating access at a client end via a click of a mouse button on an user-executable portion;
launching an application program obtained from a server;
establishing an active communication channel;
launching and registering a communication session; and
performing voice communications using a plurality of voice communication devices.
